(19) United States
(12) Patent Application Publication
(10) Pub. No.: US 2004/0267758 A1
(43) Pub. Date: Dec. 30, 2004

(54) Information processing apparatus for performing file migration on-line between file servers

(75) Inventor: Wataru Katsurashima, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/875,301

(22) Filed: Jun. 25, 2004

(30) Foreign Application Priority Data
Jun. 26, 2003 (JP) 2003-182804

(51) Int. Cl. G06F 17/00

(52) U.S. Cl. 707/10

(57) ABSTRACT

There is disclosed a file migration apparatus for migrating a file properly between file servers on-line by impersonating an owner of exclusive lock and generating a replication. A message forwarder relays forwarding of messages between clients and servers. An exclusive lock state information manager manages exclusive lock state information. In response to a request to generate a replication of a file, a file replicator asks the exclusive lock state information manager for the exclusive lock state information. If the file is in exclusive lock, the file replicator impersonates the owner of exclusive lock and generates a replication. The message forwarder blocks forwarding of messages while performing a process of maintaining consistency between the file and the replication. The file replicator checks if there is consistency between the file and the replication or not. If there is no consistency between the file and the replication, the file replicator generates a replication again. If there is consistency between the file and the replication, the file replicator switches access to the file to the replication.

### BACKGROUND OF THE INVENTION

1. Field of the Invention

The present invention relates to an apparatus for performing file migration between file servers.

2. Description of the Related Art

With the widespread use of cheap and rapid networks in recent years, there have widely been employed servers for providing file services through networks between various information systems. The servers for providing file services are referred to as file servers. The file services include NFS, CIFS, etc., for example.

File servers are operated by system administrators in order to allow users to gain smooth access to services provided by the file servers. One of the important works of operations of file servers is to migrate files between file servers. The file migration is a process of moving files between file servers.

Purposes of the file migration are as follows:

(1) To effectively utilize empty storage capacity:

By moving a file from a file server having smaller available storage capacity to a file server having larger available storage capacity, the storage capacity of the file server can effectively be utilized.

(2) To effectively utilize processing capacity:

By moving a file from a file server which is suffering a poorer response due to too much access for its processing capacity to a file server which is accessed less frequently for its processing capacity, the processing capacity of the former file server can effectively be utilized.

(3) To replace a file server:

By moving a file from an old file server to a new file server, the old file server can be replaced with the new file server.

One conventional process of performing file migration between file servers employs an apparatus which exists between a client and a server (hereinafter referred to as “intermediary apparatus”).

The system administrator instructs the intermediary apparatus to perform file migration. The instructed intermediary apparatus performs file migration between file servers according to the instruction.

“Existing between a client and a server” means existing at an intermediary position between a client and a server in a physical or logical communication route. Specifically, a request from the client goes via the intermediary apparatus to the server, which sends a response via the intermediary apparatus to the client.

The intermediary apparatus carries out a file migration process between file servers according to the following two steps:

(Step 1) Replication:

A file at a source file server is replicated consistently at a destination file server according to a file access protocol. The term “consistently” represents the completion of a sequential process effected on the file, with no inconsistency between the data of the original file and the data of the replicated file. If a portion of the file is replicated before it is changed and another portion of the file is replicated after it is changed, then the file data consistency may possibly be lost.

(Step 2) Access switching:

The file server which is accessed by the user of the client is switched from the source file server to the destination file server.

The file migration process using the intermediary apparatus offers the following advantages:

(1) When a file is replicated, it is not necessary to carry out communications between the servers for ensuring consistency of the replicated file. The reason for this is that since a process such as file data updating is performed by a request from the client to the server, the intermediary apparatus monitors and temporarily interrupts the request and a response thereto for making the replicated file consistent.

Generally, a protocol used for communications between servers is different from a file service protocol that is used between a client and a server. For performing communications between servers, the file server needs to have a protocol for communications between servers. If an intermediary apparatus performs file migration, then the file server is not required to perform communications between servers.

(2) Access switching can be made without the client having to recognize changes of the positional information of the server and the identifier of the server. The reason for this is that the intermediary apparatus is capable of performing access switching by reassigning server positional information and a server identifier when it transfers a request and a response.

There has heretofore been proposed a file migration process using an intermediary apparatus (see Yamakawa, Ishikawa, and Kikuchi “NAS switch: Development of NFS server virtualization integration technology”, The Institute of Electronics, Information and Communication Engineers, Technical Research Report Vol. 102, No. 275, pp 13-18). In this document, the NAS switch serves as an intermediary apparatus.

The conventional intermediary apparatus constructs and manages the tree structure of an integrated directory based on the public directories of servers on a pseudo-file system. The intermediary apparatus copies a file of the public directory of either one of the servers to another server while holding the tree structure of the integrated directory on the pseudo-file system. Then, the intermediary apparatus changes mapping of the tree structure on the pseudo-file system, thereby concealing movement of data from the client and keeping the tree structure of the integrated directory unchanged, and allowing the user to access the file in the server to which it is copied. The intermediary apparatus is thus effective to make up for a storage capacity shortage of server memories and reduce an excessive load on a file accessing process in some servers.

As data are transferred between servers, it is necessary to change object IDs corresponding to objects such as directories and files. The intermediary apparatus manages a history of object ID changes before and after data are moved, and prevent the client and the server from suffering drawbacks due to object ID changes, thereby concealing the movement of the data from the client. That is, after having replicated data between servers, the intermediary apparatus changes the mapping of the tree structure to switch access by the user.

According to the above conventional arrangement, since the intermediary apparatus replicates data consistently, it is not necessary to carry out communications between the servers for ensuring consistency of the replicated file. Furthermore, since the intermediary apparatus switches the transfer destination of a message from the user to perform access switching, the client does not have to recognize a change of a file identifier such as object ID upon data movement.

Another conventional system is disclosed in Japanese patent No. 3343949. Specifically, the patent discloses a distributed information processing system wherein information about the connection to a file on a server which is used by an application program on a client is saved on a magnetic disk by the server. In response to a request from the client, the server recovers the connection between the application program and the file by using the information stored in the magnetic disk.

The above conventional distributed information processing system suffers the following problems:

Usually, file migration is performed while a file server is off-line. In other words, it is general to temporarily stop the use of a file server by a client and perform file migration while the use of the file server is being stopped.

However, turning the file server off-line is liable to produce a lot of trouble inside and outside of the system. If the system is used in a company, then putting the file server off-line may cause great damage to the company. File migration is sometimes carried out at night and on holidays in order to minimize adverse effects on business activities, but such a procedure places a large burden on the system administrator.

For the above reasons, it is preferable to perform file migration while the file server is on-line. While the file server is on-line, the user is able to use file services of the file server. Specifically, the file server is turned on and connected to a communication network, and has various software settings made which are required for the user to access the file server.

When the file server is on-line, it is subject to an exclusive process to prevent data and statuses from conflicting with each other when a user accesses a file. Various exclusive processes are available depending on the file access protocol.

According to an example of exclusive process, exclusive lock is activated when a user accesses a file on a file server that is on-line. The exclusive lock serves to inhibit another user than a predetermined user from accessing a file.

Mandatory lock causes a user to be affected by exclusive lock irrespective of whether the user follows the regulations of the exclusive lock or not. For example, a user who does not follow the regulations of the exclusive lock is denied access to a file based on the type of exclusive lock on the file. Ranges of exclusive lock include overall file lock and partial file lock such as byte range lock.

Examples of file access protocols according to mandatory lock are CIFS (Common Internet File System) and NFSv4 (Network File System Version 4).

A state in which any user is opening a file (herein after referred to as “open state”) is managed by the file server. Examples of open states are (1) when an overall file is put in exclusive lock, (2) when a file is in partial file lock such as byte range lock, and (3) when an offset of a file pointer is managed. According to CIFS and NFSv4, the open state is managed.

According to another exclusive process, when a user opens a file, the user is given a binary identifier (hereinafter referred to as “token”) by the file server. CIFS uses a token.

When the file server is on-line while in an exclusive process, file migration suffers various difficulties.

While the file server is in a mandatory-lock exclusive process, the intermediary apparatus cannot replicate a file that is placed in exclusive lock by a user from a source server to a destination server. This is because if a file is placed in exclusive lock by a user, then a readout request from the intermediary apparatus is rejected by the source server.

If each file server manages the open state of a file, then when the intermediary apparatus switches access from a user to the file from a source server to a destination server, the open state on the source server becomes invalid on the destination server. When the open state becomes invalid on the destination server, since the file can be accessed by other users, data in the file may possibly be rewritten by access which should be prohibited. Inasmuch as the offset of the file pointer that has been set on the source server is cleared, the application may write data in an area which is different from the intended range. Consequently, if the open state of a file is managed by the file server, when the intermediary apparatus switches access from a user to the file, the file may possibly be destroyed.

If a user is given a token by the file server when the file is opened, then when the intermediary apparatus switches access, the application that is given the token from the source server tends to gain access to the destination server based on the token. However, the token given from the source server becomes invalid on the destination server. Therefore, the application which continues to use the same token before and after access is switched suffers an error, fails to access the file, and is put to an abnormal end.

### SUMMARY OF THE INVENTION

It is an object of the present invention to provide an apparatus which is capable of properly migrating a file between file servers that are on-line.

To achieve the above object, there is provided in accordance with the present invention an information processing apparatus for routing message communications between a plurality of servers storing files and clients for accessing the servers, comprising exclusive lock state information managing means and file replicating means. The exclusive lock state information managing means manages exclusive lock state information including information as to whether each of the files is in exclusive lock or not and information as to an owner of exclusive lock. Responsive to a request to generate a replication of a file between the servers, the file replicating means asks the exclusive lock state information managing means for the exclusive lock state information, and impersonating the owner of exclusive lock and replicating the file if the file is in exclusive lock.

The information processing apparatus may further comprise message forwarding means. The message forwarding means relays forwarding of messages between the clients and the servers and blocks forwarding of messages while performing a process of keeping consistency between the file and the replication of the file. The file replicating means checks if there is consistency between the file and the replication while the message forwarding means is blocking forwarding of messages, generates a replication of the file again if there is no consistency between the file and the replication, and switches access to the file to the replication if there is consistency between the file and the replication.

According to the present invention, there is also is provided an information processing apparatus for routing communications between a plurality of servers storing files and clients for accessing the servers, comprising open state information managing means, file replicating means, and open state reproducing means. The open state information managing means manages open state information of each of the files. The file replicating means generates a replication of a file between the servers and thereafter switching an access destination from the file to the replication. The open state reproducing means asks the open state information managing means for the open state information after the access destination is switched from the file to the replication and before first access is made to the replication, and reproduces an open state of the file in a destination server if the file is open in a source server.

The information processing apparatus may further comprise message forwarding means. The message forwarding means relays forwarding of messages between the clients and the servers and sends information included in a request message for changing the open state or a response message to the open state information managing means. The open state information managing means receives the information included in the request message for changing the open state from the message forwarding means and holds the received information, and updates the open state information when the information contained in the response message stating that a request based on the request message is accepted is received.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of a client/server system according to a first embodiment of the present invention;

FIG. 2 is a block diagram of an intermediary apparatus according to the first embodiment;

FIG. 3 is a flowchart of an operation sequence of a packet processor according to the first embodiment;

FIG. 4 is a flowchart of an operation sequence of a message forwarder according to the first embodiment;

FIG. 5 is a flowchart of an operation sequence of a file replicator according to the first embodiment;

FIG. 6 is a flowchart of an operation sequence of the file replicator according to the first embodiment for replicating a file from a source to a destination;

FIG. 7 is a flowchart of an operation sequence of the file replicator according to the first embodiment for checking whether a file to be migrated is updated or not;

FIG. 8 is a flowchart of an operation sequence of the file replicator according to the first embodiment for confirming whether an inconsistent file is not present among files to be migrated;

FIG. 9 is a flowchart of an operation sequence of the file replicator shown in FIG. 2 switches access from a client from a source to a destination;

FIG. 10 is a flowchart of an operation sequence of an exclusive lock state information manager;

FIG. 11 is a block diagram of an intermediary apparatus according to a second embodiment of the present invention;

FIG. 12 is a flowchart of an operation sequence of a message forwarder according to the second embodiment;

FIG. 13 is a flowchart of an operation sequence of the message forwarder according to the second embodiment for sending a message to an open state reproducer or a packet processor;

FIG. 14 is a flowchart of an operation sequence of a file replicator according to the second embodiment;

FIG. 15 is a flowchart of an operation sequence of the file replicator according to the second embodiment for replicating a file from a source to a destination;

FIG. 16 is a flowchart of an operation sequence of the file replicator according to the second embodiment for switching access from a client from a source to a destination;

FIG. 17 is a flowchart of an operation sequence of an open state information manager according to the second embodiment;

FIG. 18 is a flowchart of an operation sequence of the open state reproducer according to the second embodiment; and

FIG. 19 is a flowchart of an operation sequence of the open state reproducer according to the second embodiment for reproducing an open state.

### DESCRIPTION OF THE PREFERRED EMBODIMENTS

### 1st Embodiment

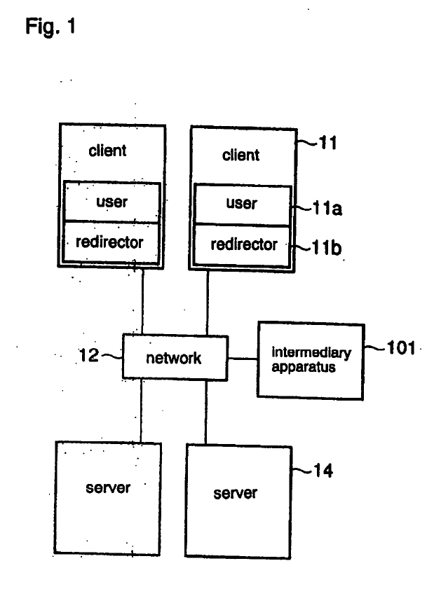

FIG. 1 shows in block form a client/server system according to a first embodiment of the present invention.

As shown in FIG. 1, the client/server system according to the first embodiment has at least one (two in FIG. 1) client 11, at least one (two in FIG. 1) server 14, and intermediary apparatus 101. Clients 11, servers 14, and intermediary apparatus 101, which each comprise a computer, are connected to network 12. Network 12 may be a LAN (Local Area Network), a MAN (Metropolitan Area Network), a WAN (Wide Area Network), the Internet, or the like.

Each client 11 is used by at least one user 11a and has at least one redirector 11b. The user represents a program for using file services or a virtual identity.

User 11a accesses files stored in each server 14 through redirector 11b. Redirector 11b redirects the access.

Each server 14 stores files to be accessed by client 11, and provides file services to each client 11. Examples of file services include NFS, CIFS, etc.

Intermediary apparatus 101 is positioned intermediate between client 11 that uses file services and server 14 that provides file services. A request from client 11 to server 14 and a response from server 14 to client 11 necessarily pass through intermediary apparatus 101. The request from client 11 to server 14 is a message signal which requests some processing. The response from server 14 to client 11 is a message signal which responds to the request.

By way of example, intermediary apparatus 101 may be physically positioned between client 11 and server 14. In FIG. 1, intermediary apparatus 101 is not physically positioned between client 11 and server 14, but logically positioned between client 11 and server 14. All requests from client 11 to server 14 and all responses from server 14 to client 11 pass through intermediary apparatus 101.

Specifically, intermediary apparatus 101, through which all requests from client 11 to server 14 pass, may comprise a proxy server, a gateway, a transparent proxy server, or a load balancer.

For example, each client 11 may set intermediary apparatus 101 as a proxy server or a gateway. For setting intermediary apparatus 101 as a transparent proxy server, routine rules may be set so as to cause packets from client 11 to server 14 to pass necessarily through intermediary apparatus 101. For setting intermediary apparatus 101 as a load balancer, intermediary apparatus 101 may be shown as a virtual server to the client.

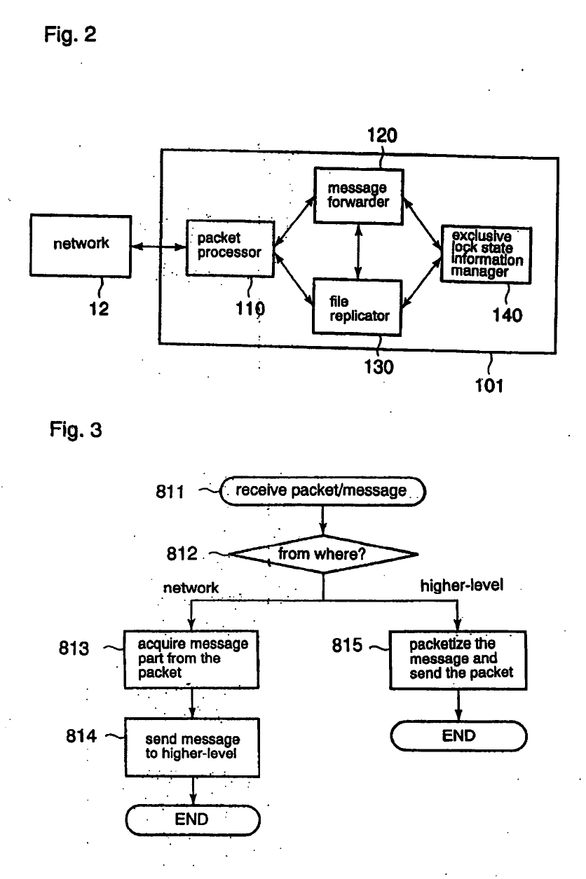

FIG. 2 shows in block form intermediary apparatus 101 according to the first embodiment. As shown in FIG. 2, intermediary apparatus 101 according to the first embodiment comprises packet processor 110, message forwarder 120, file replicator 130, and exclusive lock state information manager 140.

When packet processor 110 receives a packet from client 11 or server 14 via network 12, packet processor 110 outputs a message contained in the packet to a higher-level device. Packet processor 110 also packetizes a message output from the higher-level device and sends the packet via network 12 to client 11 or server 14. The term “message” is used herein as a generic name for requests and responses based on the file access protocol.

When message forwarder 120 receives a message from packet processor 110, message forwarder 120 checks a forwarding table (not shown) to look for the forwarding destination of the message, sets the forwarding destination as the address of the message, and sends the message to packet processor 110. The forwarding table is a mapped table of server identifiers contained in messages and servers as message forwarding destinations. The server identifiers may be IP addresses, for example.

For exclusive lock state information manager 140 to manage exclusive lock states, if a received message is a request for exclusive lock or a response thereto, then message forwarder 120 sends a copy of the message to exclusive lock state information manager 140.

During file migration, to make it possible to monitor the updating of files replicated by file replicator 130, if a received message is an updating-related request or response, then message forwarder 120 sends a copy of the message to file replicator 130. The updating-related request is a request for a process of updating file data, and the updating-related response is a response to the updating-related request.

When file replicator 130 receives an instruction for file migration from the system administrator, file replicator 130 starts operating based on the instruction. When file replicator 130 starts operating, it replicates a file between servers 14. If file replicator 130 receives a copy of a message which is an updating-related request or response while replicating a file, then file replicator 130 checks if the replicated file is updated or not. If the replicated file is updated, then the file needs to be replicated again.

If a file to be replicated is in exclusive lock, then file replicator 130 asks exclusive lock state information manager 140 for exclusive lock state information. Based on owner information contained in the exclusive lock state information, file replicator 130 impersonates the owner of the exclusive lock to read the file. The owner referred to above represents a user who is placing the file in exclusive lock or a process on the user. The owner is capable of accessing a file in exclusive lock.

When the file replication is completed, file replicator 130 rewrites the forwarding table in order to switch access from the client.

Exclusive lock state information manager 140 manages the exclusive lock state of each file. When exclusive lock state information manager 140 receives a copy of an exclusive lock request or response from message forwarder 120, it updates the exclusive lock state information. The exclusive lock request is a message requesting that a file be placed in exclusive lock or released from exclusive lock. The exclusive lock response is a message which is responsive to the exclusive lock request. The exclusive lock state information is information representative of whether each file is in exclusive lock or not and a user or a client which places each file in exclusive lock.

When exclusive lock state information manager 140 receives an inquiry from file replicator 130, exclusive lock state information manager 140 sends recorded exclusive lock state information.

An example of operation of the client/server system according to the present embodiment will be described below. It is assumed that file replicator 130 starts operating based on an instruction from the system administrator. File replicator 130 allows an interrupt from a process of another function. When there is an interrupt from another process, file replicator 130 sleeps and waits until the process is finished.

The other functions than file replicator 130 start their operation in response to the entry of data or an inquiry, and do not allow an interrupt from another process during their operation.

For permitting message forwarder 120 and file replicator 130 to cooperate with each other, file replicator 130 has two flags, i.e., a migration flag and a forward block flag.

The migration flag is a flag to indicate that file replicator 130 is in the process of migrating a file, to message forwarder 120. During file migration, message forwarder 120 uses the migration flag as it operates differently from normal operation during file migration.

The forward block flag is a flag for file replicator 130 to block the forwarding of a message from message forwarder 120. When file replicator 130 finishes the replication of a file and checks the consistency of the replicated file, the forwarding of a message from message forwarder 120 needs to be blocked. The forward block flag is used to block the forwarding of a message from message forwarder 120.

These flags are just an example used in a process of communications for allowing message forwarder 120 and file replicator 130 to cooperate with each other. Other examples than the flags used by flag replicator 130 are a process of exchanging requests and responses, a process of providing a third-party function for managing flags, and a process of relaying requests and responses with a third-party function. These processes may be combined and installed for eliminating communications.

FIG. 3 shows an operation sequence of the packet processor according to the first embodiment. As shown in FIG. 3, when file processor 110 receives data from network 12 or a higher-level device in step 811, file processor 110 starts operating. The higher-level device represents message forwarder 120 or file replicator 130.

Packet processor 110 checks the source of the received data in step 812. If the received data is a packet from network 12, then packet processor 110 acquires message part from the packet in step 813. If one packet contains a plurality of packets, then packet processor 110 obtains those packets from the packet. Packet processor 110 sends the message or messages to the higher-level device in step 814. Then, the operation sequence is put to an end.

If one message is fragmented in a plurality of packets, then packet processor 110 sends the message to the higher-level device after all the data of the message are obtained.

If the received data is from the higher-level device in step 811, then packet processor 110 packetizes the message and sends the packet to network 12 in step 815. Then, the operation sequence is put to an end.

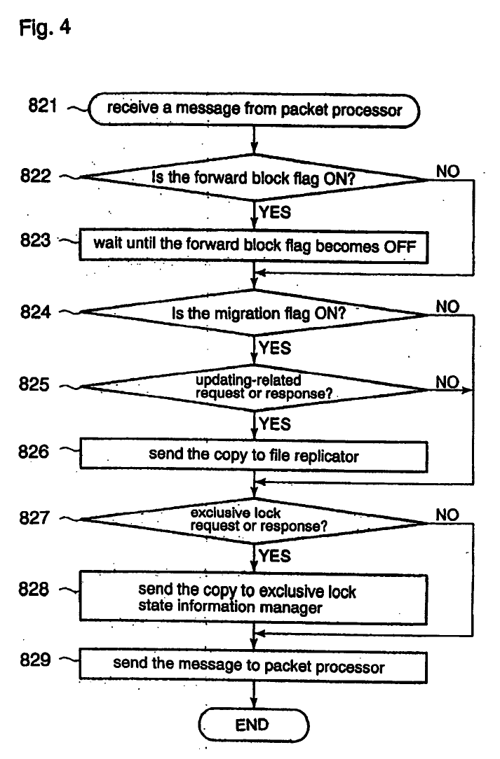

FIG. 4 shows an operation sequence of the message forwarder according to the first embodiment. As shown in FIG. 4, message forwarder 120 starts operating when it receives a message from packet processor 110 in step 821.

Message forwarder 120 checks if the forward block flag is ON or not in step 822. If the forward block flag is OFF, then message forwarder 120 goes to the processing of step 824. If the forward block flag is ON, message forwarder 120 returns to the processing of another function and waits until the forward block flag becomes OFF in step 823.

The processing of steps 822, 823 is provided for blocking communications between a client and a server as when file replicator 130 confirms whether the consistency of files is maintained between the source and the destination.

Then, message forwarder 120 checks if the migration flag is ON or not in step 824. If the migration flag is OFF, then message forwarder 120 goes to the processing of step 827. If the migration flag is ON, then message forwarder 120 checks if the message is an updating-related request or response in step 825.

If the message is neither an updating-related request nor response, then message forwarder 120 goes to the processing of step 827. If the message is an updating-related request or response, then message forwarder 120 sends a copy of the message to file replicator 130 in step 826.

The processing of steps 824 through 826 is provided for file replicator 130 to be able to confirm whether a file to be migrated is updated or not.

In step 825, message forwarder 120 checks if the message is an updating-related request or response based on the kind of a command contained in the message. The command contained in the message may be represented symbolically in the message or represented by a binary form as with a number. In either case, message forwarder 120 may check if the message is an updating-related request or response according to the specifications of the protocol. Examples of updating-related commands include a command for updating a file, a command for updating an attribute, and a command for updating a name space.

According to some protocols, the type of a command is not included in a response. In this case, when a request is received, a message number contained in the message is recorded, and when a response is received, the recorded message number is checked for determining whether the message is an updating-related request or response.

Then, message forwarder 120 checks if the message is an exclusive lock request or response in step 827. If the message is neither an exclusive lock request nor response, then message forwarder 120 goes to the processing of step 829. If the message is an exclusive lock request or response, then message forwarder 120 sends a copy of the message to exclusive lock state information manager 140 in step 828.

The processing of steps 827, 828 is provided for exclusive lock state information manager 140 to be able to record exclusive lock state information.

In step 827, message forwarder 120 checks if the message is an exclusive lock request or response based on the type of a command and a parameter contained in the message and parameters. The command and parameter contained in the message may be represented symbolically in the message or represented by a binary form as with a number. In either case, message forwarder 120 may check if the message is an exclusive lock request or response according to the specifications of the protocol.

According to some protocols, the type of a command and a parameter are not included in a response. In this case, when a request is received, a message number contained in the message is recorded, and when a response is received, the recorded message number is checked for determining whether the message is an updating-related request or response.

Finally, message forwarder 120 checks the forwarding table to look for the destination of the message, sets the destination as the address of the message, and sends the message to packet processor 110 in step 829. The forwarding table is a mapped table of IP addresses of message sending destinations and IP addresses of message forwarding destinations. Alternatively, the forwarding table may be a mapped table of volume identifiers or file identifiers, rather than server identifiers, and servers as message forwarding destinations. In this alternative, intermediary apparatus 101 manages information about which server volumes or files may be transferred to. Further alternatively, the forwarding table may be a mapped table of combinations of server identifiers, volume identifiers, and file identifiers, and servers as message forwarding destinations.

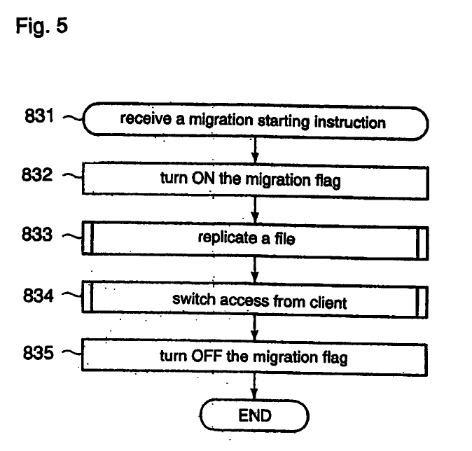

FIG. 5 shows an operation sequence of the file replicator according to the first embodiment. As shown in FIG. 5, file replicator 130 starts its processing in response to a migration starting instruction from the system administrator in step 831. With the migration starting instruction, the system administrator indicates a source and a destination.

A file belonging to the source is a file to be migrated. File replicator 130 replicates this file to the destination. The migration starting instruction from the system administrator may represent moving volume Share1 of server Server1 to volume Share2 of server Server2. In this case, file replicator 130 moves a file belonging to volume Share1 to volume Share2. While the migration starting instruction indicates movement of a volume in this case, the migration starting instruction may indicate movement of a directory, movement of a file, or movement of a server.

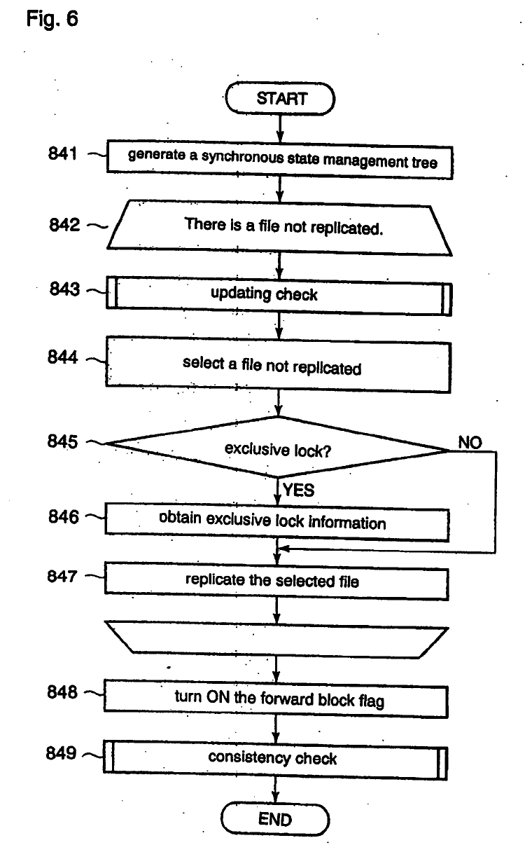

After starting its processing, file replicator 130 turns ON the migration flag in step 832. Then, file replicator 130 replicates a file from the source to the destination in step 833. Details of the processing of step 833 will be described later on with reference to a flowchart shown in FIG. 6.

Then, file replicator 130 switches access from the client from the source to the destination in step 834. Details, of the processing of step 834 will be described later on with reference to a flowchart shown in FIG. 9.

Finally, file replicator 130 turns OFF the migration flag in step 835. The operation sequence shown in FIG. 5 is now ended.

FIG. 6 shows an operation sequence of the file replicator according to the first embodiment for replicating a file from a source to a destination. As shown in FIG. 6, file replicator 130 generates a synchronous state management tree in step 841. The synchronous state management tree is descriptive of a directory tree of files to be migrated. The synchronous state management tree contains a description as to whether each file of the directory tree has been replicated or not.

For generating the synchronous state management tree, file replicator 130 sends a request for recognizing a directory tree structure to the server. For example, if the protocol is NFS, then file replicator 130 sends a request such as READDIR or READDIRPLUS to the server, and if the protocol is CIFS, then file replicator 130 sends a request such as FINDFIRST to the server. As to whether each file of the directory tree has been replicated or not, since the replicating process has not yet started at this time, the synchronous state management tree contains a description that all files are not replicated.

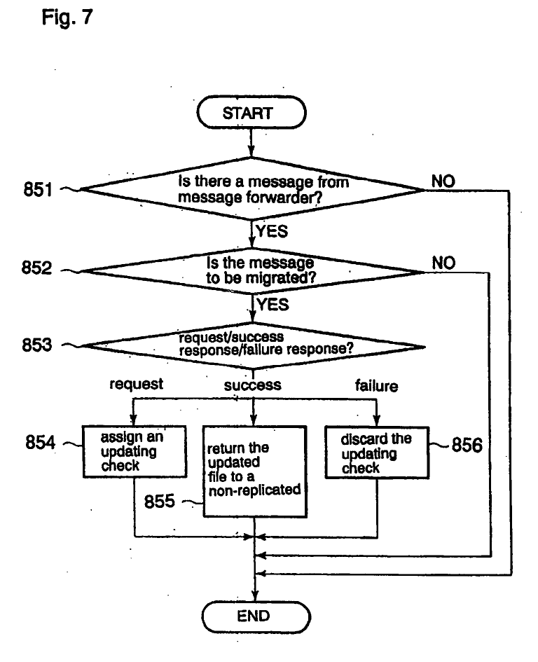

Then, file replicator 130 repeats the processing of steps 843 through 847 until all the files listed in the synchronous state management tree have been replicated and no updating checks are assigned thereto in step 842. Assignment and deletion of updating checks will be described later on with reference to FIG. 7.

Specifically, file replicator 130 checks if a file to be migrated is updated or not in step 843. Details of the processing of step 843 will be described later on with reference to FIG. 7.

Then, file replicator 130 selects a file, not replicated, from the files in the synchronous state management tree in step 844. File replicator 130 asks exclusive lock state information manager 140 to confirm whether the selected file is in exclusive lock or not in step 845.

If the selected file is in exclusive lock, then file replicator 130 goes to the processing of step 847. If the selected file is not in exclusive lock, then file replicator 130 obtains exclusive lock state information from exclusive lock state information manager 140 in step 846.

The exclusive lock state information includes information about the type of exclusive lock, the range of exclusive lock, and the owner of exclusive lock. The information about the type of exclusive lock and the range of exclusive lock indicates a range kept in exclusive lock within the file. The information about the owner of exclusive lock is used when the file in exclusive lock is replicated.

Then, file replicator 130 replicates the selected file to the destination in step 847. When the replication of the file is completed, file replicator 130 sets the file to the replicated state in the synchronous state management tree.

If the file to be replicated is in exclusive lock, then file replicator 130 uses the exclusive lock state information obtained in step 846. Specifically, file replicator 130 impersonates the owner using the information about the owner of exclusive lock which is contained in the exclusive lock state information, and replicates the file.

Though the owner of exclusive lock varies according to file access protocol, it generally represents a client, a transport such as a TCP connection, a user, a process on a user, or a combination thereof.

When there are no longer files which have not been replicated in the synchronous state management tree, file replicator 130 leaves the loop of step 842, and turns ON the forward block flag in step 848.

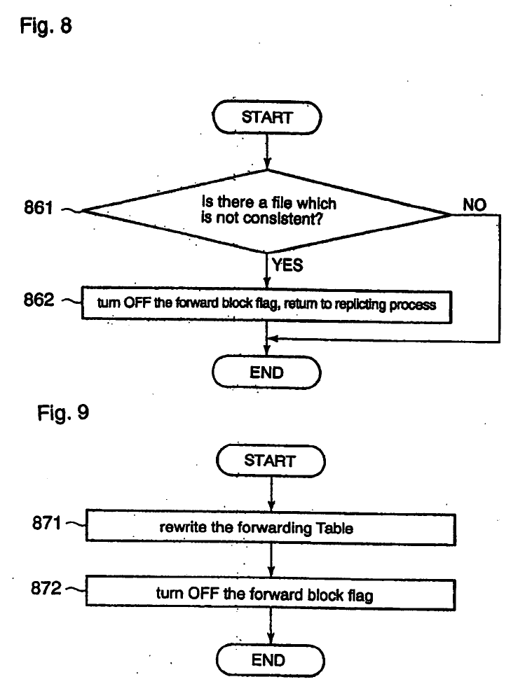

Finally, file replicator 130 confirms if there are not any replicated files that lack consistency in step 849, after which the operation sequence shown in FIG. 6 is put to an end. Details of the processing of step 849 will be described later on with reference to FIG. 8.

FIG. 7 shows an operation sequence of the file replicator according to the first embodiment for checking whether a file to be migrated is updated or not. As shown in FIG. 7, file replicator 130 determines whether there is a message from message forwarder 120 or not in step 851. If there is no message from message forwarder 120, then file replicator 130 puts its operation sequence to an end.

If there is a message from message forwarder 120, then file replicator 130 determines whether a file intended by the message is to be migrated or not in step 852.

A file intended by the message may be indicated by a file identifier contained in the message. The file identifier may be represented symbolically in the message or represented by a binary form as with a token from file server 14. If the file identifier is represented symbolically as a path name, for example, then the file can easily be identified with the file identifier. If the file identifier is represented in binary format as with a token, then it is necessary to know which file the token corresponds to according to a certain process. The token is given to the client by a response from the server when the file is successively opened. For example, the intermediary apparatus can know an association between the token and the path name by monitoring an opening request and a response. For example, the intermediary apparatus may temporarily hold the path name contained in an opening request and may record the path name in relation to the token contained in a success response.

File replicator 130 may determine whether a file intended by the message is to be migrated or not by checking if the file is managed by the synchronous state management tree or not.

If a file intended by the message is not to be migrated in step 852, then file replicator 130 puts its operation sequence to an end.

If a file intended by the message is to be migrated in step 852, then file replicator 130 checks if the message is a request, a success response, or a failure response in step 853.

If the message is a request, then file replicator 130 assigns an updating check to the file in the synchronous state management tree in step 854. At this time, it is not known whether the request is successful or not, and the file may not necessarily be updated. Therefore, file replicator 130 is unable to determine whether the file is replicated or not, and only assigns an updating check.

If the message is a success response, then file replicator 130 returns the file, to which the updating check is assigned, to a non-replicated state in step 855. That is, the replication of the file is redone.

If the message is a failure response, then file replicator 130 discards the updating check in step 856.

FIG. 8 shows an operation sequence of the file replicator according to the first embodiment for confirming whether an inconsistent file is not present among flies to be migrated. As shown in FIG. 8, file replicator 130 checks whether there is a file to be migrated which is not consistent or not in step 861. The consistency of the file may be checked by a process of comparing the updating time of the file or a process of comparing the check sum of the data of the file.

If there is not a file which is not consistent, then file replicator 130 brings its operation sequence to end. If there is a file which is not consistent, then file replicator 130 turns OFF the forward block flag, and returns to the replicating loop of step 842, i.e., to the processing of step 842, in step 862.

FIG. 9 shows an operation sequence of the file replicator shown in FIG. 2 switches access from a client from a source to a destination. As shown in FIG. 9, file replicator 130 rewrites the forwarding table to shift access to the source to the destination in step 871. Then, file replicator 130 turns OFF the forward block flag in step 872, and brings its operation sequence to end.

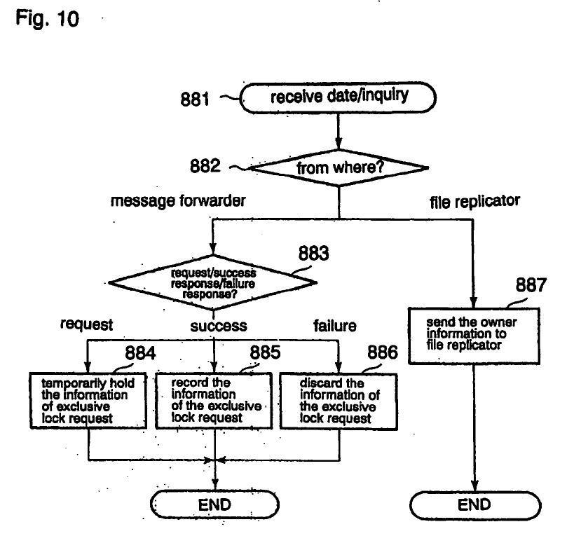

FIG. 10 shows an operation sequence of the exclusive lock state information manager. As shown in FIG. 10, exclusive lock state information manager 140 starts its processing when it receives data from message forwarder 120 or an inquiry from file replicator 130 in step 881.

Exclusive lock state information manager 140 determines whether it has received data from message forwarder 120 or an inquiry from file replicator 130 in step 882.

If exclusive lock state information manager 140 has received data from message forwarder 120, then exclusive lock state information manager 140 determines whether the data is a message representing a request, a message representing a success response, or a message representing a failure response in step 883.

If the data is a message representing a request, then exclusive lock state information manager 140 temporarily holds the information of the exclusive lock request and the message number in step 884, and then puts its operation sequence to an end.

Exclusive lock state information manager 140 holds the message number because when it subsequently receives a response, it determines which request the response is addressed to based on the message number. Exclusive lock state information manager 140 holds the information of the exclusive lock request because there is information contained only in the request, and it records the information when it receives a success response.

If the data is a message representing a success response, then exclusive lock state information manager 140 records the information of the exclusive lock request it has held, thus updating the exclusive lock state information in step 885. Thereafter, exclusive lock state information manager 140 puts its operation sequence to an end. If the data is a message representing a failure response, then exclusive lock state information manager 140 discards the information of the exclusive lock request it has held in step 886, and puts its operation sequence to an end.

In steps 885, 886, exclusive lock state information manager 140 may determine which request the response is addressed to, based on the request number.

The information of exclusive lock which is recorded includes information about the type of exclusive lock, the range of exclusive lock, and the owner of exclusive lock. The information about the type of exclusive lock represents information as to whether it is exclusive lock for files or partial exclusive lock such as byte range lock. The information about the range of exclusive lock represents information as to a range of a file which is placed in partial exclusive lock.

Though the owner of exclusive lock varies according to file access protocol, it generally represents a client, a connection, a user, a process, or a combination thereof.

The information about the type and range of exclusive lock is used to determine whether a file is in exclusive lock or not and which file range is in exclusive lock. If only a portion of a file is in exclusive lock, then the owner of exclusive lock may be impersonated only when that portion is replicated. The information about the owner of exclusive lock is used when a file in exclusive lock is replicated.

If the data is an inquiry from file replicator 130 in step 882, then exclusive lock state information manager 140 sends the exclusive lock state information to file replicator 130 if the file is in exclusive lock in step 887, and then puts its operation sequence to an end.

According to the present embodiment, message forwarder 120 forwards and monitors messages between file server 14 and client 11 according to the forwarding table. If there is an exclusive lock request or a response, then message forwarder 120 sends its contents to exclusive lock state information manager 140. If there is an updating-related request or response during file migration, then message forwarder 120 sends its contents to exclusive lock state information manager 140.

Based on the contents sent from message forwarder 120, exclusive lock state information manager 140 manages an exclusive lock state including information as to whether each file is in exclusive lock or not and information as to the owner of exclusive lock.

When file replicator 130 generates a replication of a file in file migration, file replicator 130 acquires an exclusive lock state from exclusive lock state information manager 140. If the file is in exclusive lock, file replicator 130 impersonates the owner of exclusive lock and generates a replication of the file. If file replicator 130 knows that a replicated file is updated during file migration based on the information from message forwarder 120, then file replicator 130 replicates the file again. When the replication of the consistent file is completed, file replicator 130 updates the forwarding table to switch the forwarding destination of message forwarder 120 for access from the client.

Therefore, since intermediary apparatus 101 reads a file using the information of the exclusive lock state recognized from the message, and replicates the file consistently using the information of the updating of the file recognized from the message, intermediary apparatus 101 can perform proper file migration even if it is on-line or the file is in exclusive lock.

In the present embodiment, intermediary apparatus 101 is illustrated as existing physically independently. However, the present invention is not limited to such a configuration, but intermediary apparatus 101 may be of any physical form insofar as it exists logically intermediate between client 11 and server 14.

For example, intermediary apparatus 101 may be constructed within any file servers 14. In such a case, communications between client 11 and file server 14 may occur via file server 14 which has intermediary apparatus 101 therein. Alternatively, intermediary apparatus 101 may be constructed within any clients 11. In such a case, communications between client 11 and file server 14 may occur via client 11 which has intermediary apparatus 101 therein.

In the present embodiment, CIFS and NFSv4 are given as examples of the file access protocol, and the user is the owner of exclusive lock. However, the present invention is not limited to such examples, but various entities are available for accessing files depending on the file access protocol, and hence various owners of exclusive lock are also available.

### 2nd Embodiment

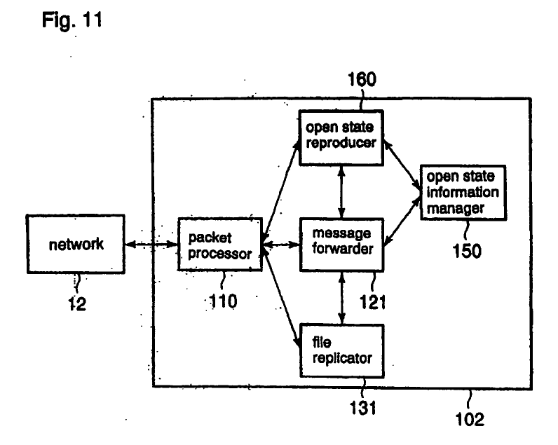

A client/server system according to a second embodiment of the present invention is of the same arrangement as the client/server system according to the first embodiment shown in FIG. 1. According to the second embodiment, however, intermediary apparatus 102 (see FIG. 11) is used instead of intermediary apparatus 101 shown in FIG. 1.

FIG. 11 shows in block form the client/server system according to the second embodiment of the present invention. As shown in FIG. 11, intermediary apparatus 102 according to the second embodiment comprises packet processor 110, message forwarder 121, file replicator 131, open state information manager 150, and open state reproducer 160.

Packet processor 110 is identical to packet processor 110 according to the first embodiment.

When message forwarder 121 receives a message from packet processor 110, message forwarder 121 checks a forwarding table (not shown) to look for the forwarding destination of the message, sets the forwarding destination as the address of the message, and sends the message to packet processor 110.

For open state information manager 150 to manage open state information, if the message is a request for changing an open state or a response thereto, then message forwarder 121 sends a copy of the message to open state information manager 150.

During file migration, to make it possible to monitor the updating of files replicated by file replicator 131, if a received message is an updating-related request or response, then message forwarder 121 sends a copy of the message to file replicator 131.

After file migration, message forwarder 121 checks if it is necessary to reproduce the open state or not. If it is necessary to reproduce the open state, then message forwarder 121 sends an open state reproducing request to open state reproducer 160 to instruct open state reproducer 160 to reproduce the open state.

Message forwarder 121 sends a message to open state reproducer 160, using the reproduced open state. Message forwarder 121 sends a message to open state reproducer 160 to cause open state reproducer 160 to perform a proxy forwarding process using the reproduced open state.

When file replicator 131 receives instructions on file migration from the system administrator, file replicator 131 starts operating based on the instructions. When file replicator 131 starts operating, it replicates a file between servers 14. If file replicator 130 receives a copy of an updating-related message while replicating a file, then fie replicator 131 checks if the replicated file is updated or not. If the replicated file is updated, then the file needs to be replicated again.

When the file replication is completed, file replicator 131 turns ON an open state reproduction flag, and thereafter rewrites the forwarding table in order to switch access from the client.

When open state information manager 150 receives a copy of a message representing a request for changing the open state information or a response thereto from message forwarder 120, open state information manager 150 manages the open state information based on the contents of the message.

When open state information manager 150 receives an inquiry from open state reproducer 160, open state information manager 150 sends the open state information it manages to open state reproducer 160.

When open state reproducer 160 receives an open state reproduction request from message forwarder 121, open state reproducer 160 reproduces the open state. After open state reproducer 160 reproduces the open state, when open state reproducer 160 receives a message to be sent in the reproduced open state from message forwarder 121, open state reproducer 160 reassigns a token to the message, and sends the message to packet processor 110 (Proxy forwarding).

An example of operation of the client/server system according to the present embodiment will be described below. It is assumed that file replicator 131 starts operating based on an instruction from the system administrator. File replicator 131 allows an interrupt from a process of another function. When there is an interrupt from another process, file replicator 131 sleeps and waits until the other process is finished.

The other functions the function of than file replicator 131 start their operation in response to the entry of data or an inquiry, and do not allow an interrupt from another process during their operation.

For permitting message forwarder 121 and file replicator 131 to cooperate with each other, there are provided three flags, i.e., a migration flag, a forward block flag, and an open state reproduction flag.

The migration flag and the forward block flag are identical to those of the first embodiment. The open state reproduction flag is a flag used by file replicator 131 to indicate, to message forwarder 121, whether an open state needs to be reproduced or not, and is set in each file server.

The open state reproduction flag is turned ON when the replication of a file and access switching are finished. When the open state reproduction flag is turned ON, the file server enters an operation mode for reproducing an open state. If it is necessary to reproduce an open state, message forwarder 121 uses the open state reproduction flag as it operates differently from normal operation.

In the present embodiment, the timing at which the open state reproduction flag is turned OFF is not limited. For example, however, the open state reproduction flag may be turned off when there is no client using a reproduced open state. When all TCP connections to a client are cut off or when all TCP connections to a server are cut off, intermediary apparatus 102 may turn OFF the open state reproduction flag.

According to another example, the period of time to be spent until the open state reproduction flag is turned OFF may be preset by the system administrator. For example, the system administrator may preset the open state reproduction flag to be turned OFF upon elapse of one month after the open state reproduction flag is turned ON, thereby preventing the open state from being reproduced. Intermediary apparatus 102 automatically turns OFF the open state reproduction flag upon elapse of the one-month period of time.

These flags are just an example used in a process of communications for allowing message forwarder 121 and file replicator 131 to cooperate with each other. Other examples than the flags used by flag replicator 131 are a process of exchanging requests and responses, a process of providing a third-party function for managing flags, and a process of relaying requests and responses with a third-party function. These processes may be combined and installed for eliminating communications.

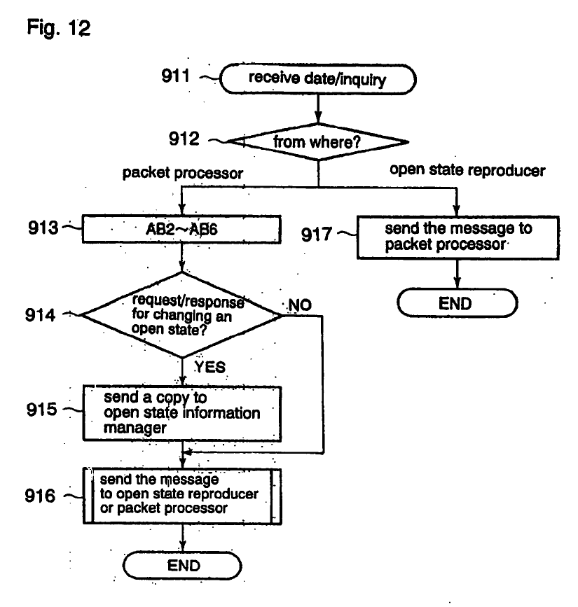

FIG. 12 shows an operation sequence of the message forwarder according to the second embodiment. As shown in FIG. 12, when message forwarder 121 receives a message from packet processor 110 or an inquiry from open state reproducer 160 in step 911, message forwarder 121 starts operating.

Message forwarder 121 determines the source of the message or the inquiry in step 912.

If message forwarder 121 receives the message from packet processor 110, then message forwarder 121 performs the processing of steps 822 through 826 shown in FIG. 4 in step 913, as with the first embodiment.

Then, message forwarder 121 checks if the message is a request for changing an open state or a response thereto in step 914. If the message is neither a request for changing an open state nor a response thereto, then message forwarder 121 goes to the processing of step 916.

If the message is a request for changing an open state or a response thereto, then message forwarder 121 sends a copy of the message to open state information manager 150 in step 915. Message forwarder 121 can check if the message is a request for changing an open state or a response thereto from the type of a command contained in the message. The command contained in the message may be represented symbolically in the message or represented in binary format as with a number. In either case, message forwarder 121 may check if the message is a request for changing an open state or a response thereto according to the specifications of the protocol. Examples of commands for changing an open state include OPEN, CLOSE, LOCK, UNLOCK, and DELETE.

According to some protocols, the type of a command is not included in a response. In this case, when a request is received, a message number contained in the message is recorded, and when a response is received, the recorded message number is checked for determining the type f the command.

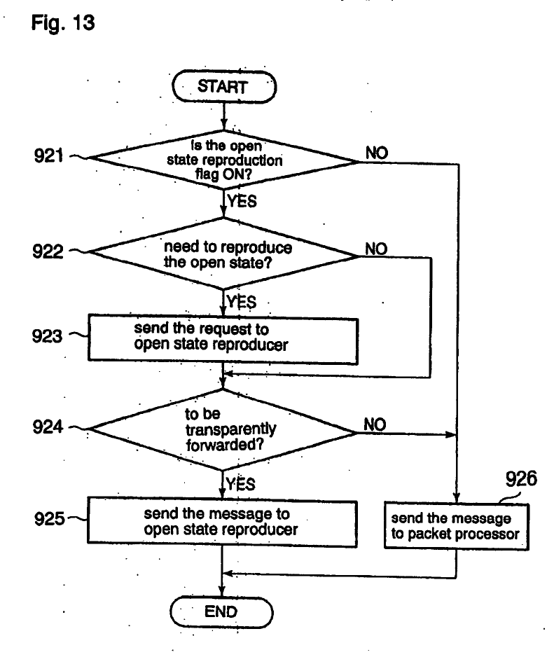

Finally, message forwarder 121 sends a message to open state reproducer 160 or packet processor 110 in step 916, after which the operation sequence shown in FIG. 12 is put to an end. Details of the processing of step 916 will be described later on with reference to FIG. 13.

If message forwarder 121 receives the inquiry from open state reproducer 160 in step 912, then message forwarder 121 sends a message to packet processor 110 in step 917, and then puts its processing to an end.

FIG. 13 shows an operation sequence of the message forwarder according to the second embodiment for sending a message to the open state reproducer or the packet processor. As shown in FIG. 13, message forwarder 121 checks if the open state reproduction flag is ON or not in step 921.

If the open state reproduction flag is OFF, then message forwarder 121 checks the forwarding table to look for the forwarding destination of the message, sets the forwarding destination as the address of the message, and sends the message to packet processor 110 in step 926. Thereafter, message forwarder 121 puts its processing to an end.

If the open state reproduction flag is ON, then message forwarder 121 determines whether a file intended by the message needs to have its open state reproduced or not in step 922.

A file intended by the message may be indicated by a file identifier contained in the message. The file identifier may be represented symbolically in the message as with a path name, or represented in binary format as with a token from file server 14. If the file identifier is represented symbolically as a path name, for example, then the file can easily be identified from the file identifier. If the file identifier is represented in binary format as with a token, then it is necessary to know which file the token corresponds to according to a certain process. The token is given to the client by a response from the server when the file is successively opened. For example, the intermediary apparatus can know an association between the token and the path name by monitoring an opening request and a response.

Message forwarder 121 determines whether a file intended by the message needs to have its open state reproduced or not by referring to a synchronous state management tree. The synchronous state management tree is different from the synchronous state management tree according to the first embodiment in that it describes whether each file has its open state reproduced or not. If the file is managed by the synchronous state management tree and its open state is not reproduced, then the open state of the file needs to be reproduced.

Managing a file with a synchronous state management tree means that the file has been to be migrated. If the answer to step 922 is YES (a file intended by the message needs to have its open state reproduced), a file which is to be migrated, has been replicated, but has its open state not reproduced is intended by the message.

If a file intended by the message does not need to have its open state reproduced in step 922, then message forwarder 121 goes to the processing of step 924.

If a file intended by the message needs to have its open state reproduced in step 922, then message forwarder 121 sends an open state reproduction request to open state reproducer 160 in step 923, and waits until the reproducing process is finished.

Then, message forwarder 121 checks if the message uses the reproduced open state, i.e., checks if the message is a message to be transparently forwarded or not, in step 924.

Step 924 is provided for converting a token transferred from a source server to a client into a token acquired from a destination server by the intermediary apparatus, with respect to a message which uses a reproduced open state.

Which open state is used by a message can be identified by a token which is contained in the message and transferred from a server when the file is opened. Normally, a token is installed as a file identifier in a message. Whether a message uses a reproduced open state or not can be determined based on whether the token is described in an open state reproduction table or not. The open state reproduction table is a table representing an association between tokens transferred to destination servers and tokens transferred from source servers prior to the reproduction.

According to some file access protocols, an open state cannot be identified unless not only a token transferred from a server when a file is opened, but also various tokens including a token transferred when the user is authenticated and a token transferred when access to a volume where a file exists is permitted, are used. In such a case, whether an open state used by a message has been reproduced or not can be determined by describing these other tokens in the open state reproduction table.

If the message does not use the reproduced open state in step 924, then message forwarder 121 refers to the forwarding table to look for the forwarding destination of the message, sets the forwarding destination as the address of the message, and sends the message to packet processor 110 in step 926.

If the message uses the reproduced open state in step 924, then message forwarder 121 sends the message to open state reproducer 160 in step 925, and puts its processing to an end.

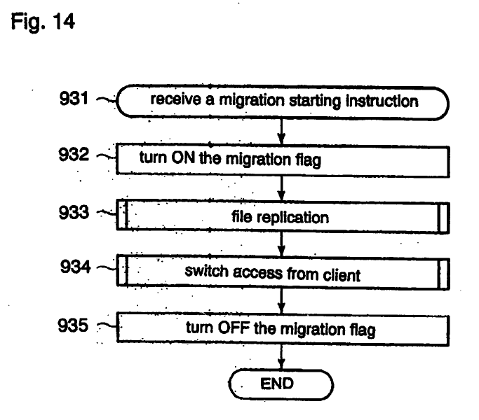

FIG. 14 shows an operation sequence of the file replicator according to the second embodiment. As shown in FIG. 14, file replicator 131 starts its processing in response to a migration starting instruction from the system administrator in step 931. After starting its processing, file replicator 131 turns ON the migration flag in step 932.

Then, file replicator 131 replicates a file from the source to the destination in step 933. Then, file replicator 131 switches access from the client from the source to the destination in step 934. Finally, file replicator 131 turns OFF the migration flag in step 935. The operation sequence shown in FIG. 14 is now ended.

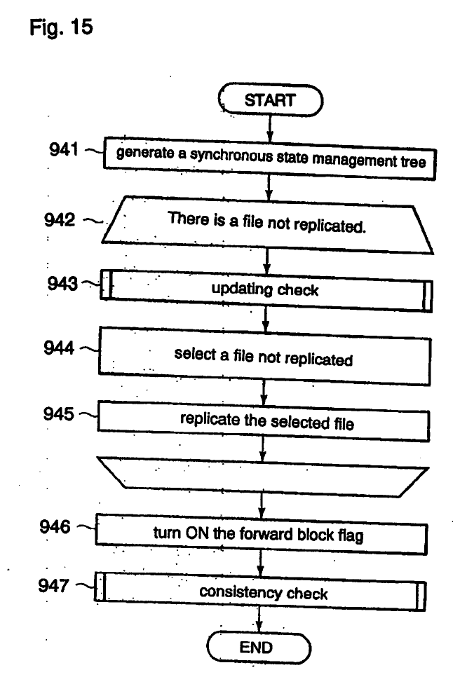

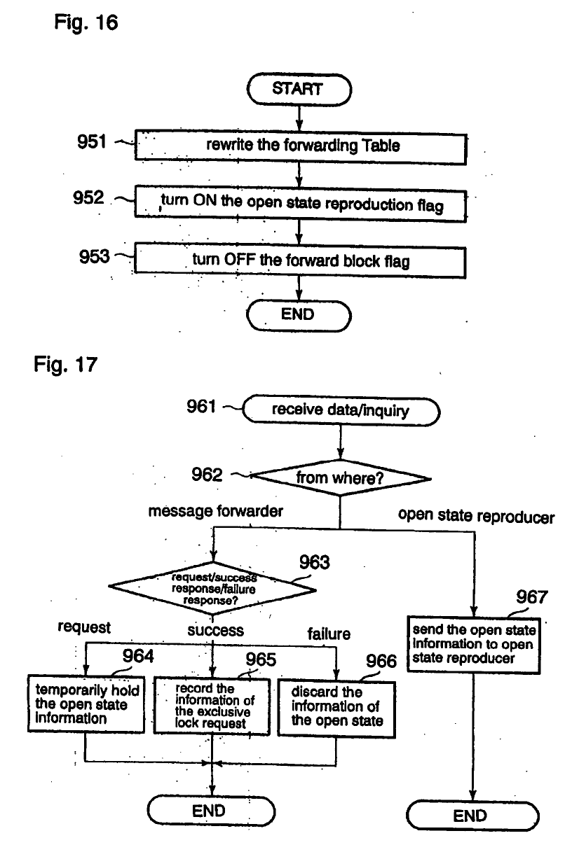

Steps 931 through 935 are identical to the steps of the operation sequence according to the first embodiment shown in FIG. 5. However, the details of the processing of steps 933, 934 are different from those of the corresponding steps according to the first embodiment. The details of the processing of step 933 will be described below with reference to FIG. 15, and the details of the processing of step 934 will be described below with reference to FIG. 16.

FIG. 15 shows an operation sequence of the file replicator according to the second embodiment for replicating a file from a source to a destination. As shown in FIG. 15, file replicator 131 generates a synchronous state management tree in step 941. The synchronous state management tree is descriptive of a directory tree of files to be migrated. The synchronous state management tree contains a description as to whether each file of the directory tree has been replicated or not. Unlike the synchronous state management tree according to the first embodiment, the synchronous state management tree according to the first embodiment describes whether each file has its open state reproduced or not.

Then, file replicator 131 repeats the processing of steps 943 through 945 until all the files listed in the synchronous state management tree have been replicated and updating checks are assigned thereto, in step 942.

Specifically, file replicator 131 checks if a file to be migrated is updated or not in step 943. Details of the processing of step 943 are identical to those of the corresponding step shown in FIG. 7.

Then, file replicator 131 selects a file, not replicated, from the files in the synchronous state management tree in step 944. Then, file replicator 131 replicates the selected file to the destination in step 945. When the replication of the file is completed, file replicator 131 sets the file to the replicated state in the synchronous state management tree. In the operation sequence shown in FIG. 15, since other details than the features of the present embodiment are simplified, the file access protocol is of the mandatory lock type and migration is not finished if the file is in exclusive lock. However, this may be resolved as with steps 845 through 847 according to the first embodiment.

When there are no longer files which have not been replicated in the synchronous state management tree, file replicator 131 leaves the loop of step 942, and turns ON the forward block flag in step 946.

Finally, file replicator 131 confirms if there are not any replicated files that lack consistency in step 947, after which the operation sequence shown in FIG. 15 is put to an end. Details of the processing of step 947 are identical to those of the corresponding step according to the first embodiment shown in FIG. 8.

FIG. 16 shows an operation sequence of the file replicator according to the second embodiment for switching access from a client from a source to a destination. As shown in FIG. 16, file replicator 131 rewrites the forwarding table to shift access to the source to the destination in step 951. Then, file replicator 131 turns ON the open state reproduction file in step 952. Finally, file replicator 131 turns OFF the forward block flag in step 953, and brings its operation sequence to end.

FIG. 17 shows an operation sequence of the open state information manager according to the second embodiment as shown in FIG. 17, open state information manager 150 starts its processing when it receives data from message forwarder 121 or an inquiry from open state reproducer 160 in step 961.

Open state information manager 150 determines whether it has received data from message forwarder 121 or an inquiry from open state reproducer 160 in step 962.

If open state information manager 150 has received data from message forwarder 121, then open state information manager 150 determines whether the data is a message representing a request, a message representing a success response, or a message representing a failure response in step 963.

If the data is a message representing a request, then open state information manager 150 temporarily holds the information of the request for changing the open state and the message number from the message in step 964, and then puts its operation sequence to an end.

Open state information manager 150 holds the message number because when it subsequently receives a response, it determines which request the response is addressed to based on the message number. Open state information manager 150 holds the information of the request for changing the open state because there is information contained only in the request, and it records the information when it receives a success response, i.e., the request is accepted. Examples of the information contained only in the request are the type of lock, the range of lock, and a file pointer.

If the data is a message representing a success response, then open state information manager 150 records the information of the open state from the information it has held in step 965. Thereafter, open state information manager 150 puts its operation sequence to an end.

If the data is a message representing a failure response, then open state information manager 150 discards the information it has held in step 966, and puts its operation sequence to an end.

In steps 985, 966, open state information manager 150 may determine which request the response is addressed to, based on the request number.

The information of the open state which is recorded includes information as to lock for an entire file, partial lock such as byte range lock, and an offset state of a file pointer.

In order to manage an open state identifiably, open state information manager 150 records open state information for each token assigned to a message. Usually, a token is installed as a file identifier in a message.

According to some file access protocols, an open state cannot be identified unless not only a token transferred from a server when a file is opened, but also various tokens including a token transferred when the user is authenticated and a token transferred when access to a volume is permitted, are used. In such a case, open state information may be described for each combination of tokens.

If open state information manager 150 has received an inquiry from open state reproducer 160 in step 962, then open state information manager 150 sends open state information to open state reproducer 160 in step 967, and then puts its processing to an end.

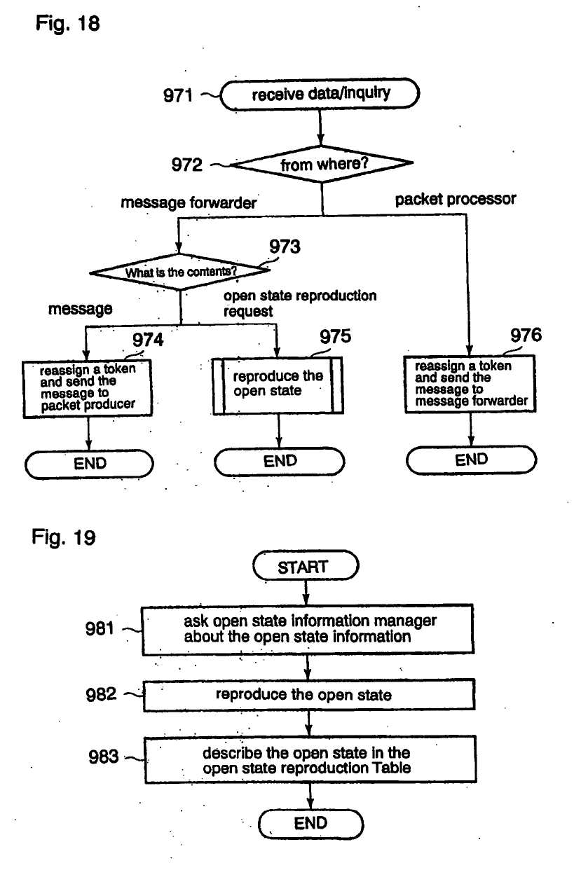

FIG. 18 shows an operation sequence of the open state reproducer according to the second embodiment. As shown in FIG. 18, open state reproducer 160 starts its processing when it receives data from message forwarder 121 or packet processor 110 in step 971. First, open state reproducer 160 checks the source of the data in step 972.

If open state reproducer 160 receives data from message forwarder 121, then open state reproducer 160 determines the contents of the data in step 973.

It the data is a message, then open state reproducer 160 reassigns a token of the message and sends the message to packet processor 110 in step 974 to perform a proxy forwarding process, after which the operation sequence is put to an end. At this time, open state reproducer 160 refers to the open state reproduction table, and reassigns a token transferred from the source server to the client in place of a token transferred from the destination server to intermediary apparatus 102 as a client proxy.

If the data is an open state reproduction request in step 973, then open state reproducer 160 reproduces an open state in step 976, and puts its processing to an end. Details of the processing of step 975 will be described later on with reference to FIG. 19.

If the data is received from packet processor 110 in step 972, then open state reproducer 160 reassigns a token of the message of the data, and sends the data to message forwarder 121 in a process which is a reversal of step 974 in step 976. Then, open state reproducer 160 puts its processing to an end.

FIG. 19 shows an operation sequence of the open state reproducer according to the second embodiment for reproducing an open state. As shown in FIG. 19, open state reproducer 160 asks open state information manager 150 about the open state information of a file intended by the message, using a file identifier included in the message in step 981. If open state reproducer 160 receives a response stating that no user has set an open state for the file from open state manager 150, then open state reproducer 160 puts its operation sequence to an end without further processing. A plurality of users may set an open state for a single file.

If open state reproducer 160 receives a response stating that at least one open state information has been set, then open state reproducer 160 reproduces the open state in step 982. At this time, open state reproducer 160 reproduces open states one by one. Open state reproducer 160 opens a file in the destination server when it reproduces the open state. When open state reproducer 160 is permitted to open a file, it receives a token from the destination server.

Then, open state reproducer 160 associates a token transferred from the destination server when it is permitted to open a file and a token that has been transferred from the source server to the user before the open state is reproduced, with each other, and describes the association information in the open state reproduction table in step 983.

According to some file access protocols, an open state cannot be identified unless not only a token transferred from a server when a file is opened, but also various tokens including a token transferred when the user is authenticated and a token transferred when access to a volume is permitted, are used. In such a case, other tokens are described in the open state reproduction table.

According to the present embodiment, message forwarder 121 forwards and monitors messages between file server 14 and client 11 according to the forwarding table. If there is a request for changing an open state or a response thereto, then message forwarder 121 sends its contents to open state information manager 150. If there is an updating-related request or response during file migration, then message forwarder 121 sends its contents to file replicator 131. Message forwarder 121 checks if there is a need for reproducing an open state after file migration or not. If there is such a need, then message forwarder 121 sends an open state reproduction request to open state reproducer 160. If there is a message to be sent with an open state reproduced, then message forwarder 121 sends the message to open state reproducer 160 for proxy forwarding, rather than to packet processor 110.

Based on the contents sent from message forwarder 121, open state information manager 150 manages open state information by recording the open state of each file in relation to a token. When open state information manager 150 receives an inquiry from open state reproducer 160, open state information manager 150 sends the managed open state information to open state reproducer 160.

File replicator 131 generates a replication of a file in file migration. If file replicator 131 recognizes that the replicated file is updated during file migration based on data from message forwarder 121, file replicator 131 replicates the file again. When the replication of the consistent file is completed, file replicator 131 updates the forwarding table to switch the forwarding destination of message forwarder 121 for access from the client.

When open state reproducer 160 receives an open state reproduction request from message forwarder 121, open state reproducer 160 asks open state information manager 150 to reproduce an open state and records associated information of the token in the open state reproduction table. After having reproduced the open state, open state reproducer 160 reassigns a token of the message to be sent with the open state reproduced according to the open state reproduction table, and forwards the message as a proxy of message forwarder 121.

Consequently, since intermediary apparatus 102 can switch access from the client after having replicated the file consistently and reproduced the open state, it can perform file migration while the open state is being continued according to the file access protocol in which the open state is managed. Files are not destroyed and applications are not put to an abnormal end even when file migration is performed on-line.

In the present embodiment, the open state reproduction flag is set for each file server. However, the open state reproduction flag may not necessary be set for each file server, but may be set for each migration event or each file.

If the open state reproduction flag is set for each file, the open state reproduction flag is turned ON when a replication of the file is completed. However, the open state reproduction flag is turned ON with respect to only a file that needs to have its open state reproduced, or stated otherwise, only a file with its open state set in the source server. If the user no longer uses an open state set in the source server, then the open state reproduction flag may be turned OFF. For example, the fact that the open state is no longer used may be recognized when the TCP connection from the client which has been used by the user is cut off. The open state reproduction flag may also be turned OFF simply upon elapse of a predetermined period of time after the open state reproduction flag has been turned ON.

While preferred embodiments of the present invention have been described using specific terms, such description is for illustrative purposes only, and it is to be understood that changes and variations may be made without departing from the spirit or scope of the following claims.

What is claimed is:

1. An information processing apparatus for routing message communications between a plurality of servers storing files and clients for accessing the servers, comprising:
exclusive lock state information managing means for managing exclusive lock state information including information as to whether each of the files is in exclusive lock or not and information as to an owner of exclusive lock; and
file replicating means responsive to a request to generate a replication of a file between the servers, asking said exclusive lock state information managing means for said exclusive lock state information, and replicating the file while impersonating the owner of exclusive lock if the file is in exclusive lock.

2. An information processing apparatus according to claim 1, further comprising:
message forwarding means for relaying forwarding of messages between said clients and said servers and blocking forwarding of messages while performing a process of keeping consistency between said file and the replication of the file;
wherein said file replicating means checks if there is consistency between said file and said replication while said message forwarding means is blocking forwarding of messages, generates a replication of the file again if there is no consistency between said file and said replication, or switches access to said file to said replication if there is consistency between said file and said replication.

3. An information processing apparatus according to claim 1, wherein said exclusive lock state information managing means manages, as the information as to the owner of exclusive lock, information for identifying a client, a transport, a user, a process, or a combination of at least two of the client, the transport, the user, and the process.

4. An information processing apparatus according to claim 1, wherein said exclusive lock state information managing means manages information as to a range of exclusive lock included in said exclusive lock state information, in addition to the information as to whether each file is in exclusive lock or not and the information as to the owner of exclusive lock; and
said file replicating means refers to the information as to the range of exclusive lock, and impersonates the owner of exclusive lock when a range of said file which is in exclusive lock is replicated.

5. An information processing apparatus according to claim 1, wherein said exclusive lock state information managing means holds information included in a request message for requesting exclusive lock from a client to a server, and updates said exclusive lock state information based on the held information when a response message stating that a request based on said request message is accepted is sent from said server.

6. An information processing apparatus for routing communications between a plurality of servers storing files and clients for accessing the servers, comprising:
open state information managing means for managing open state information of each of the files;
file replicating means for generating a replication of a file between said servers and thereafter switching an access destination from said file to said replication; and
open state reproducing means for asking said open state information managing means for said open state information after the access destination is switched from said file to said replication and before first access is made to said replication, and reproducing an open state of said file in a destination server if said file is open in a source server.

7. An information processing apparatus according to claim 6, further comprising:
message forwarding means for relaying forwarding of messages between said clients and said servers and sending information included in a request message for changing the open state or in a response message to said open state information managing means;
wherein said open state information managing means receives the information included in the request message for changing the open state from said message forwarding means and holds the received information, and updates said open state information when the information contained in the response message stating that a request based on said request message is accepted is received.

8. An information processing apparatus according to claim 6, wherein said open state reproducing means opens said replication in said destination server for said file which has been opened in said source server, acquires a first token from said destination server, and records an association between said first token and a second token which has been transferred from said source server to the user of a client when the file was opened in said source server by the user, thereby reproducing the open state.

9. An information processing apparatus according to claim 8, wherein said open state reproducing means records an association between a third token transferred from said source server to said user when the user was authenticated, or a fourth token transferred from said source server to said user when a volume where said file exists was accessed, and a corresponding token transferred from said destination server, when the open state is reproduced.

10. A method of managing a file in a server in an information processing apparatus for routing communications between a plurality of servers storing files and clients for accessing the servers, comprising the steps of:
managing exclusive lock state information including information as to whether each of the files is in exclusive lock or not and information as to an owner of exclusive lock; and
responsive to a request to generate a replication of a file between the servers, referring to said exclusive lock state information, and impersonating the owner of exclusive lock while replicating the file if the file is in exclusive lock.

11. A method according to claim 10, further comprising the steps of:
blocking forwarding of messages between said clients and said servers while performing a process of keeping consistency between said file and the replication of the file; and
checking if there is consistency between said file and said replication while forwarding of messages is blocked, generating a replication of the file again if there is no consistency between said file and said replication, or switching access to said file to said replication if there is consistency between said file and said replication.

12. A method according to claim 10, wherein the information as to the owner of exclusive lock is represented by information for identifying a client, a transport, a user, a process, or a combination of at least two of the client, the transport, the user, and the process.

13. A method according to claim 10, wherein information as to a range of exclusive lock included in said exclusive lock state information is managed in addition to the information as to whether each file is in exclusive lock or not and the information as to the owner of exclusive lock, and the information as to the range of exclusive lock is referred to, and the owner of exclusive lock is impersonated when a range of said file which is in exclusive lock is replicated.

14. A method according to claim 10, further comprising the steps of:
holding information included in a request message for requesting exclusive lock from a client to a server; and
updating said exclusive lock state information based on the held information when a response message stating that a request based on said request message is accepted is sent from said server.

15. A method of managing a file in a server in an information processing apparatus for routing communications between a plurality of servers storing files and clients for accessing the servers, comprising the steps of:
managing open state information of each of the files;
responsive to a request to generate a replication of a file between the servers, generating a replication of a file between said servers and switching an access destination from said file to said replication; and
after the access destination is switched from said file to said replication and before first access is made to said replication, reproducing an open state of said file in a destination server if said file is open in a source server according to said open state information.

16. A method according to claim 15, further comprising the steps of:
responsive to a request message for changing the open state, holding information contained in said request message; and
updating said open state information when information contained in a response message stating that a request based on said request message is accepted is received.

17. A method according to claim 15, further comprising the steps of:
opening said replication in said destination server for said file which was opened in said source server;
acquiring a first token from said destination server; and
recording an association between said first token and a second token which has been transferred from said source server to the user of a client when the file was opened in said source server by the user, thereby reproducing the open state.

18. A method according to claim 17, further comprising the step of:
recording an association between a third token transferred from said source server to said user when the user is authenticated, or a fourth token transferred from said source server to said user when a volume where said file exists was accessed, and a corresponding token transferred from said destination server, when the open state is reproduced.

19. A file management program for having an information processing apparatus managing a file in a server, where said apparatus is routing communications between a plurality of servers storing files and clients for accessing the servers, comprising the processes of:
managing exclusive lock state information including information as to whether each of the files is in exclusive lock or not and information as to an owner of exclusive lock; and
responsive to a request to generate a replication of a file between the servers, referring to said exclusive lock state information, and replicating the file while impersonating the owner of exclusive lock if the file is in exclusive lock.

20. A file management program according to claim 19, further comprising the processes of:
blocking forwarding of messages between said clients and said servers while performing a process of keeping consistency between said file and the replication of the file; and
checking if there is consistency between said file and said replication while forwarding of messages is blocked, generating a replication of the file again if there is no consistency between said file and said replication, or switching access to said file to said replication if there is consistency between said file and said replication.

21. A file management program according to claim 19, wherein the information as to the owner of exclusive lock is represented by information for identifying a client, a transport, a user, a process, or a combination of at least two of the client, the transport, the user, and the process.

22. A file management program according to claim 19, wherein information as to a range of exclusive lock included in said exclusive lock state information is managed in addition to the information as to whether each file is in exclusive lock or not and the information as to the owner of exclusive lock, and the information as to the range of exclusive lock is referred to, and the owner of exclusive lock is impersonated when a range of said file which is in exclusive lock is replicated.

23. A file management program according to claim 19, further comprising the processes of:
holding information included in a request message for requesting exclusive lock from a client to a server; and
updating said exclusive lock state information based on the held information when a response message stating that a request based on said request message is accepted is sent from said server.

24. A file management program for having an information processing apparatus managing a file in a server, where said apparatus is routing communications between a plurality of servers storing files and clients for accessing the servers, comprising the processes of:
managing open state information of each of the files;
responsive to a request to generate a replication of a file between the servers, generating a replication of a file between said servers and switching an access destination from said file to said replication; and
after the access destination is switched from said file to said replication and before first access is made to said replication, reproducing an open state of said file in a destination server if said file is open in a source server according to said open state information.

25. A file management program according to claim 24, further comprising the processes of:
responsive to a request message for changing the open state, holding information contained in said request message; and
updating said open state information when information contained in a response message stating that a request based on said request message is accepted is received.

26. A file management program according to claim 24, further comprising the processes of:
opening said replication in said destination server for said file which has been opened in said source server;
acquiring a first token from said destination server; and
recording an association between said first token and a second token which has been transferred from said source server to the user of a client when the file was opened in said source server by the user, thereby reproducing the open state.

27. A file management program according to claim 26, further comprising the process of:
recording an association between a third token transferred from said source server to said user when the user was authenticated, or a fourth token transferred from said source server to said user when a volume where said file exists was accessed, and a corresponding token transferred from said destination server, when the open state is reproduced.
